(19) United States
(12) Patent Application Publication
(10) Pub. No.: US 2015/0354514 A1
(43) Pub. Date: Dec. 10, 2015

(54) FUEL SUPPLY SYSTEM AND METHOD OF SUPPLYING FUEL TO ENGINE

(71) Applicant: Caterpillar Inc., Peoria, IL (US)

(72) Inventor: Toby Perry, Minooka, IL (US)

(21) Appl. No.: 14/298,091

(22) Filed: Jun. 6, 2014

(51) Int. Cl. F02M 37/12

(52) U.S. Cl. CPC F02M 37/12

(57) ABSTRACT

A fuel supply system for an engine is disclosed. The fuel supply system includes a fuel pump defining a fuel chamber and a hydraulic chamber. The fuel chamber is in fluid communication with a fuel source and the hydraulic chamber is in fluid communication with a hydraulic pump that supplies a pressurized hydraulic fluid. In a suction stroke of a fuel piston in the fuel chamber, a valve system provides a first portion of hydraulic fluid to hydraulic chamber to drive the fuel piston in a first direction and provides a second portion of hydraulic fluid to the accumulator. In a compression stroke, the valve system provides hydraulic fluid to hydraulic chamber to drive the fuel piston in a second direction. Further, the accumulator releases the stored fluid to hydraulic chamber to drive the fuel piston in the second direction.

### TECHNICAL FIELD

The present disclosure relates to a fuel supply system and method of supplying fuel, and more particularly to a fuel supply system and method of supplying fuel to an engine.

### BACKGROUND

A dual fuel internal combustion or gaseous fuel engine may be used in a locomotive machine for propelling the same. Such dual fuel or gaseous fuel internal combustion engine may also be used in machines used for the purpose of construction, mining, agriculture and other industries. In case of duel fuel engines, the engine typically includes a fuel supply system for supplying gaseous fuel such as natural gas, and a liquid fuel such as gasoline or diesel. In order to provide natural gas to the engine efficiently, the natural gas is cooled to a liquid state and stored in a cryogenic tank. A fuel pump is used to pressurize the liquefied fuel to a heat exchanger which in turn converts the liquefied fuel to gaseous state for supply to the engine.

The fuel pump is driven by a hydraulic system that includes a hydraulic pump. The hydraulic pump derives a power from the engine to drive the fuel pump. The fuel pump typically draws in the liquefied fuel during a suction stroke and pressurizes the liquefied fuel during a compression stroke. During the suction stroke, the liquefied fuel enters the fuel pump at a slow rate and a low pressure. Thus, the suction stroke requires less power from the engine as the hydraulic pump needs to supply the hydraulic fluid to the fuel pump at low pressure and low flow rate. However, during the compression stroke of the fuel pump, the liquefied fuel is pressurized at a faster rate and at a higher pressure as compared to during the suction stroke. Thus, the compression stroke requires higher power from the engine as the hydraulic pump needs to supply the hydraulic fluid at a higher pressure and faster flow rate. A difference of power requirement from the engine between the suction stroke and the compression stroke requires a high change in a power output of the hydraulic pump over a short duration. Consequently, the load applied on the engine by the hydraulic pump also changes rapidly by a high value. This may be undesirable during operation of the engine.

U.S. Pat. No. 5,222,875 discloses a hydraulic pump system. The hydraulic pump system includes a variable displacement pump and an engine for driving the variable displacement pump. A power takeoff unit is used for engaging or disengaging the engine to the variable displacement pump. The variable displacement pump supplies pressurized hydraulic fluid to drive a hydraulic motor that drives a liquid pump. The hydraulic motor is in communication with a hydraulic fluid cooler that is further communicated with a hydraulic fluid reservoir. The hydraulic fluid reservoir is in communication with the inlet of the variable displacement pump. The hydraulic pump system further includes hydraulic piping and/or hose for connecting the hydraulic motor, cooler reservoir and variable displacement pump. The hydraulic piping and/or hose may be disposed with filters.

### SUMMARY OF THE DISCLOSURE

In one aspect of the present disclosure, a fuel supply system for an engine is disclosed. The fuel supply system includes a fuel source. A fuel pump is in fluid communication with the fuel source. The fuel pump includes a fuel chamber configured to receive a fuel therein from the fuel source. A hydraulic chamber is configured to receive a hydraulic fluid therein. A fuel piston is slidably received within the fuel chamber. The fuel piston is being configured to compress the fuel during a compression stroke thereof and to draw in the fuel into the fuel chamber during a suction stroke thereof. The fuel piston is drivable by the hydraulic fluid received within the hydraulic chamber. A hydraulic pump is drivably connected to the engine. The hydraulic pump is configured to provide pressurized hydraulic fluid. A valve system is fluidly disposed between the hydraulic pump and the fuel pump. An accumulator is disposed in fluid communication with the valve system. In the suction stroke of the fuel piston, the valve system is configured to provide a first portion of pressurized hydraulic fluid to the hydraulic chamber of the fuel pump to drive the fuel piston in a first direction and to provide a second portion of pressurized hydraulic fluid to the accumulator for storage. In the compression stroke of the fuel piston, the valve system is configured to provide pressurized hydraulic fluid to the hydraulic chamber of the fuel pump to drive the fuel piston in a second direction. The accumulator is configured to selectively release the stored pressurized fluid to the hydraulic chamber of the fuel pump to facilitate the drive of the fuel piston in the second direction.

In another aspect of the present disclosure, a machine is disclosed. The machine includes an engine and a hydraulic pump that is drivably connected to the engine. The hydraulic pump is configured to provide a pressurized hydraulic fluid. A valve system is in fluid communication with the hydraulic pump. An accumulator is disposed in fluid communication with the valve system. The machine further includes a fuel source and a fuel pump that is in fluid communication with the fuel source and the valve system. The fuel pump includes a fuel chamber configured to receive a fuel therein from the fuel source and a hydraulic chamber configured to receive the pressurized hydraulic fluid therein from the valve system. A fuel piston is slidably received within the fuel chamber. The fuel piston is being configured to compress the fuel during a compression stroke thereof and to draw in the fuel into the fuel chamber during a suction stroke thereof. The fuel piston is drivable by the hydraulic fluid received within the hydraulic chamber. In the suction stroke of the fuel piston, the valve system is configured to provide a first portion of the pressurized hydraulic fluid to the hydraulic chamber of the fuel pump to drive the fuel piston in a first direction and to provide a second portion of the pressurized hydraulic fluid to the accumulator for storage. In the compression stroke of the fuel piston, the valve system is configured to provide the pressurized hydraulic fluid to the hydraulic chamber of the fuel pump to drive the fuel piston in a second direction. The accumulator is configured to selectively release the stored pressurized fluid to the hydraulic chamber of the fuel pump to facilitate the drive of the fuel piston in the second direction.

In yet another aspect of the present disclosure, a method of supplying a fuel to an engine with a hydraulic system is disclosed. The hydraulic system includes a hydraulic pump drivably coupled to the engine to provide pressurized hydraulic fluid to a hydraulic chamber. The hydraulic chamber is associated with a movement of a fuel piston of a fuel pump to compress the fuel within a fuel chamber during a compression stroke and to draw in fuel within the fuel chamber during a suction stroke. In the suction stroke, a valve system is moved to a first configuration to facilitate providing a first portion of pressurized fluid to the hydraulic chamber of the fuel pump to drive the fuel piston in a first direction and providing a second portion of pressurized fluid to an accumulator for storage. In the compression stroke, the valve system is moved to a second configuration to facilitate providing pressurized hydraulic fluid to the hydraulic chamber of the fuel pump to drive the fuel piston in a second direction. Further, in the compression stroke, stored pressurized fluid within the accumulator is selectively released to the hydraulic chamber of the fuel pump to facilitate the drive of the fuel piston in the second direction.

Other features and aspects of this disclosure will be apparent from the following description and the accompanying drawings.

### BRIEF DESCRIPTION OF THE DRAWINGS

FIG. 1 shows a schematic representation of an exemplary machine;

FIG. 2 is a block diagram illustrating a fuel supply system for an engine of the machine, according to an embodiment of the present disclosure;

FIG. 3 is a block diagram illustrating a hydraulic system for driving a fuel pump of the fuel supply system, according to an embodiment of the present disclosure;

FIG. 4 is a block diagram of the hydraulic system of FIG. 3 in another operational configuration; and

FIG. 5 is a flow chart illustrating a method of supplying fuel to the engine with the hydraulic system, according to an embodiment of the present disclosure.

### DETAILED DESCRIPTION

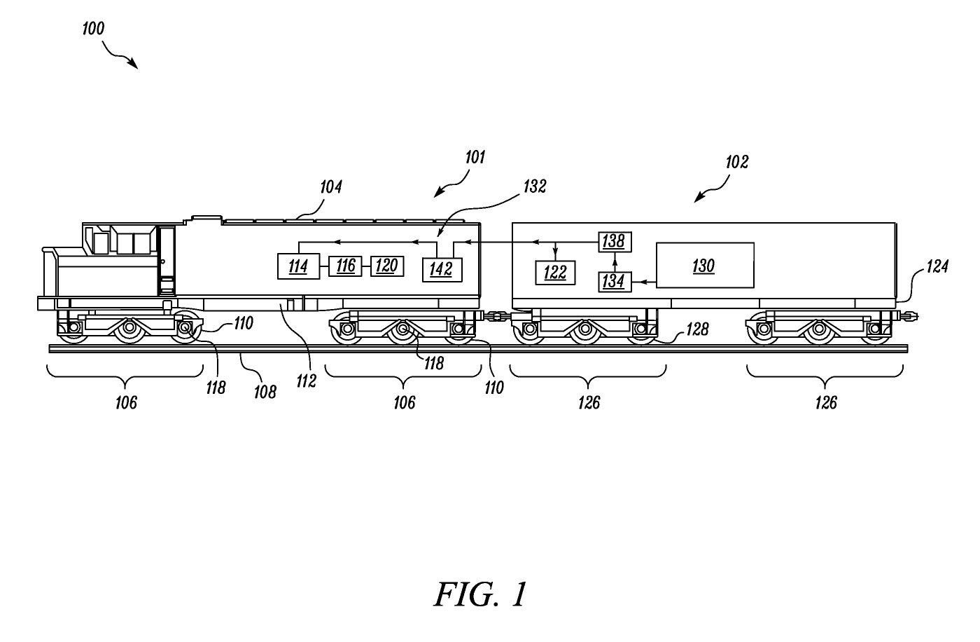

FIG. 1 shows a schematic representation of an exemplary machine 100, according to an embodiment of the present disclosure. The machine 100 includes a locomotive 101 and a tender car 102 that is towed by the locomotive 101. In other embodiments, additional cars may be towed by the locomotive 101, for example, a passenger car or a cargo container car. The locomotive 101 may include a body 104 supported at opposing ends by a plurality of trucks 106. Each truck 106 may be engaged to a track 108 via a plurality of wheels 110 and supports a frame 112 of the body 104. The locomotive 101 also includes an engine 114 that may be mounted on the frame 112. The engine 114 is further adapted to drive the plurality of wheels 110 that is included within each of the trucks 106. In the embodiment of FIG. 1, the locomotive 101 shows one engine 114; however, it is contemplated that the locomotive 101 may include any number of engines. Although, the machine 100 in the embodiment of FIG. 1 illustrates a locomotive, in various other embodiments, the machine 100 may include an on-highway or off-highway vehicle. Also, the machine 100 may include vehicles used in various industries, such as construction, mining, agriculture, etc.

The engine 114 may include a single cylinder or multiple cylinders. The multiple cylinders may be arranged in various configurations such as inline, rotary, v-type, etc. The engine 114 may be a dual fuel internal combustion engine propelled by a gaseous fuel such as, for example, natural gas, propane, methane, hydrogen, and like. In the embodiment of FIG. 1, the gaseous fuel may be a natural gas stored as liquefied natural gas (LNG) and provided to the engine 114 in gaseous state. Further, the engine 114 may use a liquid fuel that may be, for example, gasoline or diesel. In an alternative embodiment, the engine 114 may be a gaseous fuel engine adapted to run only on gaseous fuel.

In the embodiment of FIG. 1, the engine 114 may generate mechanical power that drives a generator 116. Additionally, the engine 114 may also be coupled with various other components including, but not limited to, water pumps, implement pumps, etc. The generator 116 is adapted to produce electric power. The electric power from the generator 116 may be used to propel the locomotive 101 via one or more traction motors 118 associated with the wheels 110. Additionally, the electric power may be directed to one or more auxiliary loads 120, for example, lights, heaters, refrigeration devices, air conditioners, fans, etc.

The tender car 102 may be provided with an auxiliary engine 122 that is drivably connected to an auxiliary generator (not shown). The auxiliary engine 122 and the auxiliary generator may be mounted to a frame 124 that is supported by a plurality of trucks 126. Similar to truck 106, each truck 126 may be engaged to the track 108 via a plurality of wheels 128.

The auxiliary engine 122 may be smaller and have a lower rated output compared to that of the engine 114. Similar to the engine 114, the auxiliary engine 122 may combust a fuel to generate mechanical power used to rotate the auxiliary generator. The auxiliary generator may produce an auxiliary supply of electric power directed to one or more of the auxiliary loads 120.

The tender car 102 may include a fuel source 130 for storing LNG and supplying to the engine 114 and the auxiliary engine 122. The fuel source 130 may be an insulated, single or multi-walled tank configured to store LNG at a low temperature, for example, about −160° C. A fuel supply system 132 may supply LNG from the fuel source 130 to the engine 114 and to the auxiliary engine 122. The fuel supply system 132 may include, among other things, a fuel pump 134, a heat exchanger 138 and an accumulator 142. It may be contemplated that the fuel supply system 132 may include additional fuel pump 134, heat exchanger 138 and accumulator 142.

As shown in FIG. 1, the fuel pump 134 may be situated outside or within the fuel source 130. In the embodiment of FIG. 1, the fuel pump 134 may be a cryogenic piston pump. However, in alternative embodiments, the fuel pump 134 may be a centrifugal pump, or any other pump that are known in the art. The fuel pump 134 may be powered by the engine 114 and/or the auxiliary engine 122.

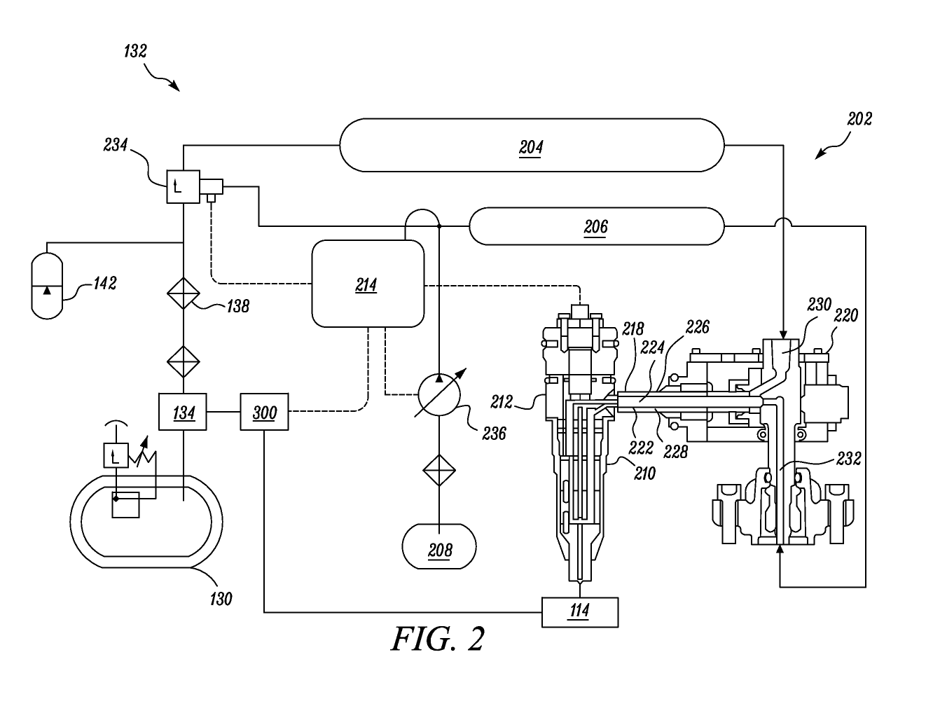

FIG. 2 shows a block diagram illustrating the fuel supply system 132, according to an embodiment of the present disclosure. In the embodiment of FIG. 2, only the engine 114 is shown for illustration purposes. The engine 114 may include a common rail system 202 including a gaseous fuel common rail 204 and a liquid fuel common rail 206. The gaseous fuel common rail 204 may be fluidly coupled with the fuel pump 134 to receive a pressurized natural gas. The liquid fuel common rail 206 may be fluidly communicated with a liquid fuel reservoir 208 to receive a liquid fuel therefrom.

A fuel injector 210 may be provided in each of the cylinders of the engine 114. The fuel injector 210 may include an injector body 212. The injector body 212 may define one end provided with an outlet for discharging fuel into the cylinder of the engine 114. The fuel delivered from the fuel injector 210 may be natural gas or liquid fuel. The injector body 212 may be electrically communicated with a controller 214. The fuel injector 210 may be configured to discharge fuel into the cylinder upon receipt of a control signal from the controller 214. The controller 214 may send the control signal based on an input received from an operator. Further, the controller 214 is electrically communicated with the fuel injector 210 to control timing and quantity of the fuel discharged into the cylinders during a fuel injection event of the fuel supply system 132. The fuel injector 210 may be further fluidly communicated with a connecting element 218.

The connecting element 218 may be fluidly coupled between the fuel injector 210 of each of the cylinders and a quill assembly 220. The connecting element 218 may include an inner tube 222 that defines an inner passage 224. An outer tube 226 may be disposed around the inner tube 222 to define an outer passage 228 between the inner tube 222 and the outer tube 226. The inner passage 224 of the connecting element 218 may be fluidly coupled with a first channel 232 provided at one end of the quill assembly 220. The outer passage 228 of the connecting element 218 may be fluidly coupled with a second channel 230 provided at another end of the quill assembly 220. Further, the first channel 232 of the quill assembly 220 may be fluidly communicated with the liquid fuel common rail 206 and the second channel 230 may be fluidly communicated with the gaseous fuel common rail 204 of the common rail system 202.

The fuel pump 134 is in fluid communication with the fuel source 130 for supplying the natural gas to the engine 114 via the gaseous fuel common rail 204 and the fuel injector 210.

The fuel supply system 132 further includes a first pressure regulator 234. The first pressure regulator 234 may be an electrically actuated valve communicated with the controller 214. The first pressure regulator 234 may be in fluid communication with the gaseous fuel common rail 204 to control a pressure of the compressed natural gas in the gaseous fuel common rail 204. In an embodiment, the first pressure regulator 234 may be configured to supply a controlled quantity of the pressurized fuel from the accumulator 142 to the gaseous fuel common rail 204.

The fuel supply system 132 further includes a pump 236. The pump 236 may be a high pressure liquid fuel pump of a type well known in the art. Further, the pump 236 may also be actuated electrically to communicate with the controller 214. The pump 236 may be further in fluid communication between the liquid fuel common rail 206 and the liquid fuel reservoir 208 to control pressure of the liquid fuel in the liquid fuel common rail 206 upon receipt of a control signal from the controller 214.

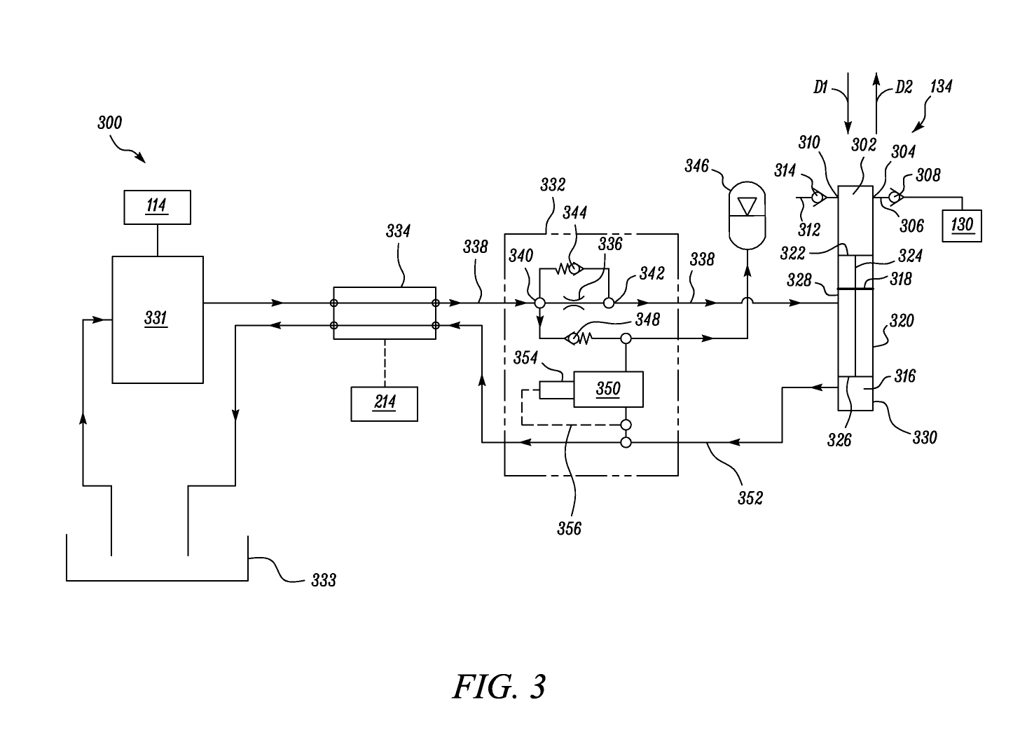

FIG. 3 shows a block diagram illustrating a hydraulic system 300 for driving the fuel pump 134 of the fuel supply system 132, according to an embodiment of the present disclosure. The fuel pump 134 includes a fuel chamber 302 configured to receive the LNG therein from the fuel source 130. The fuel chamber 302 may be provided with an inlet port 304 fluidly coupled with the fuel source 130 via a liquefied natural gas (LNG) line 306. A check valve 308 may be disposed in the LNG line 306. The check valve 308 may be configured to restrict a return flow of LNG from the fuel chamber 302 to the fuel source 130.

Further, the fuel chamber 302 may be provided with an outlet port 310 which is fluidly communicated with the gaseous fuel common rail 204 via the heat exchanger 138. Another check valve 314 may be disposed in a CNG line 312. The check valve 314 may be configured to restrict the pressurized LNG from returning to the fuel chamber 302.

The fuel pump 134 includes a hydraulic chamber 316 configured to receive a hydraulic fluid therein. The fuel chamber 302 and the hydraulic chamber 316 may be provided within a single cylinder 320 and separated from each other by a sealing member 318. The sealing member 318 may provide a fluid tight seal between the fuel chamber 302 and the hydraulic chamber 316. However, it may be contemplated that the fuel pump 134 may include two separate cylinders defining the fuel chamber 302 and the hydraulic chamber 316. The fuel pump 134 further includes a fuel piston 322 that is slidably received within the fuel chamber 302. The fuel piston 322 may be configured to receive the fuel from the fuel source 130 through the inlet port 304 during a suction stroke of the fuel piston 322. The suction stroke of the fuel piston 322 may be defined as a travel of the fuel piston 322 along a first direction D1 within the fuel chamber 302. Further, the fuel piston 322 may be configured to compress the fuel during a compression stroke of the fuel piston 322. The compression stroke of the fuel piston 322 may be defined as a travel of the fuel piston 322 along a second direction D2 within the fuel chamber 302. The fuel piston 322 may be connected to a piston rod 324 that may extend to the hydraulic chamber 316 of the fuel pump 134 through the sealing member 318.

In the hydraulic chamber 316, the piston rod 324 may be connected to a hydraulic piston 326. Thus, the piston rod 324 may be slidably disposed within the sealing member 318 such that the piston rod 324 is slidable along with the fuel piston 322 and the hydraulic piston 326. The piston rod 324 may be disposed in the sealing member 318 in such a way to ensure a fluid tight seal between the fuel chamber 302 and the hydraulic chamber 316. The hydraulic piston 326 of the hydraulic chamber 316 defines a rod end 328 and a head end 330 within the hydraulic chamber 316. The hydraulic chamber 316 of the fuel pump 134 is fluidly communicated to a hydraulic pump 331 and a hydraulic tank 333 through a valve system 332 and a directional valve 334. The hydraulic pump 331 is a fixed displacement pump. In various embodiments, the hydraulic pump 331 may be a centrifugal pump, rotary pump and alike. The hydraulic pump 331 may be drivably connected to the engine 114 via, for example, gear drive, belt drive or chain drive, to receive a power to operate the hydraulic pump 331. Upon starting of the engine 114, the hydraulic pump 331 may receive a hydraulic fluid from the hydraulic tank 333 and supply a pressurized hydraulic fluid to the directional valve 334.

The valve system 332 includes an orifice member 336 that may be disposed in a first fluid line 338. In the embodiment of FIG. 3, the orifice member 336 is a fixed orifice member. The first fluid line 338 may be fluidly coupled between the rod end 328 of the hydraulic chamber 316 and the directional valve 334. The orifice member 336 may include a first end 340 and a second end 342. The first end 340 of the orifice member 336 may be fluidly coupled with the directional valve 334 via the first fluid line 338 and the second end 342 of the orifice member 336 may be fluidly coupled with the rod end 328 of the hydraulic chamber 316 via the first fluid line 338. The orifice member 336 may be configured to provide a restriction to the pressurized hydraulic fluid supplied by the hydraulic pump 331. Thus, the orifice member 336 may ensure a controlled flow of the pressurized hydraulic fluid to the rod end 328 of the hydraulic chamber 316. In an embodiment, the orifice member 336 may provide a variable restriction to the pressurized hydraulic fluid based on a control signal from the controller 214. In further embodiments, the orifice member 336 may be actuated based on an input from an operator of the machine 100.

The valve system 332 further includes a first check valve 344 fluidly communicated with the first end 340 and the second end 342 of the orifice member 336. Thus, the first check valve 344 may allow a unidirectional flow of the hydraulic fluid from the rod end 328 of the hydraulic chamber 316 to the directional valve 334.

The hydraulic system 300 further includes an accumulator 346 that is fluidly communicated with the first fluid line 338 to receive the pressurized hydraulic fluid supplied by the hydraulic pump 331. In particular, the accumulator 346 may be fluidly coupled with the first end 340 of the orifice member 336 to receive the pressurized hydraulic fluid and store the hydraulic fluid. A second check valve 348 may be fluidly disposed between the first end 340 of the orifice and the accumulator 346 to allow a unidirectional flow of the pressurized hydraulic fluid to the accumulator 346.

A discharge valve 350 may be fluidly coupled between the accumulator 346 and a second fluid line 352. The second fluid line 352 may be in fluid communication between the directional valve 334 and the fuel pump 134. The second fluid line 352 is fluidly coupled with the head end 330 of the hydraulic chamber 316. In an embodiment, the discharge valve 350 may be a two-port two-position valve. One port may be fluidly communicated with the accumulator 346 and the other port may be fluidly coupled with the second fluid line 352. The discharge valve 350 may also include a valve body movable between an open position and a closed position. The discharge valve 350 may include an actuator 354 that may be fluidly coupled with a pilot line 356. The valve body may be actuated upon receipt of an input from the second fluid line 352 via the pilot line 356. The input may be a pressure of the hydraulic fluid that flows through the second fluid line 352 during the compression stroke of the fuel piston 322. In an alternative embodiment, the discharge valve 350 may be an electrically actuated valve. The valve body may be actuated upon receipt of a control signal from the controller 214.

The directional valve 334 is further fluidly coupled to the hydraulic tank 333. The directional valve 334 may be a four-port three-position valve. The four ports may be fluidly coupled to the hydraulic pump 331, the hydraulic tank 333, the first fluid line 338 and the second fluid line 352. The directional valve 334 may include a valve body that is movable between a first position, a second position and a neutral position. In one example, the directional valve 334 includes a solenoid (not shown) such that the valve body of the directional valve 334 may be electrically actuated upon receipt of a control signal from the controller 214 to move between the first position and the second position. The valve body may be in neutral position in idle condition of the directional valve 334. In the first position, the hydraulic pump 331 may be fluidly communicated with the rod end 328 of the hydraulic chamber 316, and in the second position; the hydraulic pump 331 may be fluidly communicated with the head end 330 of the hydraulic chamber 316. Further, in the first position, the hydraulic tank 333 may be fluidly communicated with the head end 330 of the hydraulic chamber 316, and in the second position, the hydraulic tank 333 may be fluidly communicated with the rod end 328 of the hydraulic chamber 316. In the neutral position, the directional valve 334 may prevent flow between the hydraulic chamber 316, and the hydraulic pump 331 and the hydraulic tank 333.

Referring to FIG. 3, in the suction stroke of the fuel piston 322, the valve body of the directional valve 334 moves to the first position upon receipt of the control signal from the controller 214. In the first position of the directional valve 334, the pressurized hydraulic fluid from the hydraulic pump 331 is supplied to the rod end 328 of the hydraulic chamber 316 via the first fluid line 338. Also, the head end 330 of the hydraulic chamber 316 may be fluidly communicated with the hydraulic tank 333 to drain the hydraulic fluid from the hydraulic chamber 316. As the pressurized hydraulic fluid flows through the orifice member 336, the flow rate of the pressurized hydraulic fluid may be restricted by the orifice member 336. Therefore, a portion of the pressurized fluid from the hydraulic pump 331 may branch from the first end 340 of the orifice member 336 and flow through the second check valve 348. The orifice member 336 may also result in a drop in pressure of the hydraulic fluid flowing therethrough. Hence, the pressure of the hydraulic fluid may also be controlled by the orifice member 336 in order to drive the fuel piston 322 along the first direction D1 to draw in the fuel within the fuel chamber 302. The first check valve 344 may not allow the pressurized hydraulic fluid to bypass the orifice member 336. When the fuel piston 322 travels along the first direction D1, the fuel from the fluid source may be received in the fuel chamber 302 through the inlet port 304 of the fuel chamber 302 via the LNG line 306.

During the suction stroke, the hydraulic pump 331 may receive the power from the engine 114 to supply the pressurized hydraulic fluid to the hydraulic chamber 316. The orifice member 336 may also be configured to provide a first portion of the pressurized hydraulic fluid that is supplied by the hydraulic pump 331 to the hydraulic chamber 316. The first portion of the pressurized hydraulic fluid may be defined as an amount of the pressurized hydraulic fluid that is to be supplied to the rod end 328 of the hydraulic chamber 316 to drive the fuel piston 322 along the first direction D1 and draw the LPG in the fuel chamber 302. Due to pressure drop across the orifice member 336, the first portion of the hydraulic fluid may enter the hydraulic chamber 316 at a lower pressure compared to a pressure at which the hydraulic fluid is supplied by the hydraulic pump 331. Consequently, the fuel piston 322 may travel at a slow rate than a rate at which the fuel piston 322 may travel based on the pressure at which the hydraulic fluid is supplied by the hydraulic pump 331.

The second check valve 348 of the valve system 332 may be fluidly communicated with the first fluid line 338 to allow a second portion of the pressurized hydraulic fluid to the accumulator 346 for storage. The second portion of the pressurized hydraulic fluid may be defined as an amount of the pressurized hydraulic fluid diverted through the second check valve 348 to the accumulator 346 while providing the first portion of the hydraulic fluid through the orifice member 336 to the hydraulic chamber 316. The second portion of the pressurized hydraulic fluid may branch off from the first fluid line 338 and flow through the second check valve 348 due to the restriction to fluid flow provided by the orifice member 336. The second portion of the pressurized hydraulic fluid may be stored in the accumulator 346 at a predetermined pressure. The hydraulic fluid stored in the accumulator 346 may be released during the compression stroke of the fuel piston 322, as will be explained hereinafter in more detail. The discharge valve 350 may remain in the closed position as the pressure of hydraulic fluid in the second fluid line 352 during the suction stroke may be less than a pressure required to actuate the discharge valve 350 via the pilot line 356.

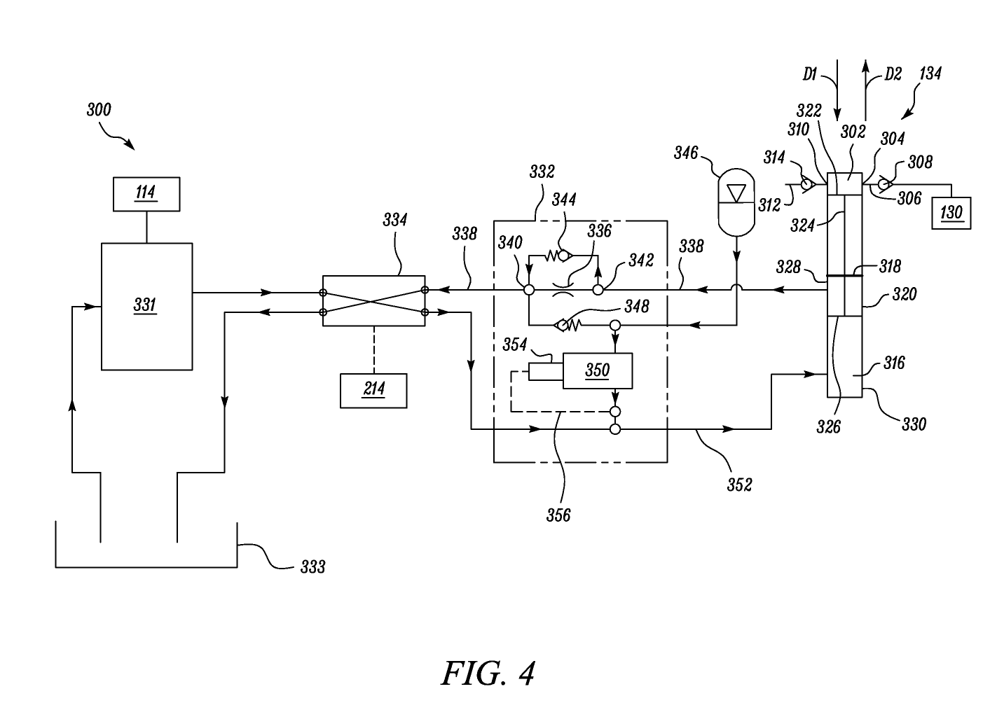

FIG. 4 shows a block diagram illustrating the hydraulic system 300 for driving the fuel piston 322 during the compression stroke of the fuel piston 322. In the compression stroke, the valve body of the direction valve 334 moves to the second position upon receipt of the control signal from the controller 214. In the second position, the pressurized hydraulic fluid is supplied through the second fluid line 352 and is provided to the head end 330 of the hydraulic chamber 316. Further, the rod end 328 of the hydraulic chamber 316 may be fluidly communicated with the hydraulic tank 333 to drain the hydraulic fluid from the rod end 328 of the hydraulic chamber 316. In an embodiment, the hydraulic pump 331 may supply the pressurized hydraulic fluid to the head end 330 of the hydraulic chamber 316 at a pressure substantially equal to the pressure during the suction stroke of the fuel pump 134. Therefore, a power required by the hydraulic pump 331 may remain about the same during the suction and compression strokes of the fuel pump 134. Consequently, a load applied on the engine 114 by the hydraulic pump 331 may remain substantially same during the suction and compression strokes. Further, the discharge valve 350 that is disposed between the accumulator 346 and the second fluid line 352 may be actuated upon receipt of the input from the second fluid line 352 via the pilot line 356. In the actuated condition of the discharge valve 350, the valve body of the discharge valve 350 may move to the open position to allow the pressurized hydraulic fluid stored in the accumulator 346 to the head end 330 of the hydraulic chamber 316. Thus, the hydraulic fluid may enter the head end 330 of the hydraulic chamber 316 at a pressure higher than the pressure of the hydraulic fluid that is received in the hydraulic chamber 316 during the suction stroke. Hence, the pressurized hydraulic fluid drives the fuel piston 322 to travel along the second direction D2 at a rate faster than the rate at which the fuel piston 322 travels during the suction stroke. When the fuel piston 322 travels along the second direction D2, the LNG present in the fuel chamber 302 may be pressurized and the pressurized LNG may then pass through the heat exchanger 138 and the gaseous fuel common rail 204.

### INDUSTRIAL APPLICABILITY

A fuel supply system of a dual fuel or a gaseous fuel internal combustion engine includes a fuel pump for pressurizing a fuel, such as liquefied natural gas (LNG). The pressurized LPG is then supplied to a heat exchanger for conversion to CNG which is then supplied to the engine. The fuel pump may be driven by a hydraulic system that includes a hydraulic pump. The hydraulic pump may be drivably coupled with the engine. During a suction stroke of the fuel pump, the hydraulic pump provides a pressurized hydraulic fluid to the fuel pump in order to draw in LNG. During a compression stroke of the fuel pump, the hydraulic pump may apply a higher load on the engine than a load applied during the suction stroke. This difference of load applied on the engine between the suction stroke and the compression stroke of the fuel pump over a short duration may not be desirable.

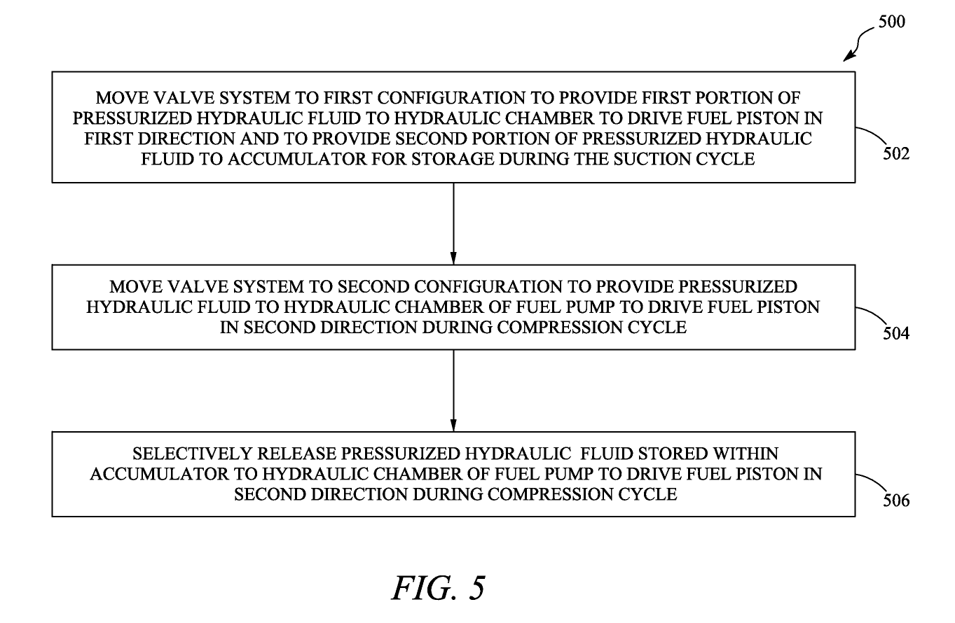

The present disclosure relates to the hydraulic system 300 for driving the fuel pump 134 of the fuel supply system 132. FIG. 5 illustrates a method 500 for driving the fuel pump 134 with the hydraulic system 300, according to an embodiment of the present disclosure. The hydraulic pump 331 supplies the pressurized hydraulic fluid to the hydraulic chamber 316 via the directional valve 334 and the valve system 332. The pressurized hydraulic fluid received in the hydraulic chamber 316 drives the fuel piston 322 along the first direction D1 during the suction stroke. Thus, during the suction stroke, LNG is received in the fuel chamber 302 through the inlet port 304 from the fuel source 130. LNG is then pressurized in the fuel chamber 302 by driving the fuel piston 322 along the second direction D2 during the compression stroke.

At step 502, the valve system 332 of the hydraulic system 300 is moved to a first configuration. The first configuration of the valve system 332 is associated with the suction stroke of the fuel piston 322. During the suction stroke, the valve body of the directional valve 334 moves to the first position upon receipt of the control signal from the controller 214. In the first position of the directional valve 334, the hydraulic pump 331 fluidly communicates with the first fluid line 338. The pressurized hydraulic fluid passes through the orifice member 336. As the first check valve 344 allows unidirectional flow of the hydraulic fluid from the rod end 328 of the hydraulic chamber 316 to the directional valve 334, the first check valve 344 may not allow the pressurized hydraulic fluid to bypass the orifice member 336. When the fuel piston 322 travels along the first direction D1, LNG from the fuel source 130 may be received in the fuel chamber 302 through the inlet port 304 of the fuel chamber 302 via the LNG line 306.

During the suction stroke, a flow rate and pressure of the pressurized hydraulic fluid supplied by the hydraulic pump 331 may be higher than a flow rate and pressure required during the suction stroke of the fuel piston 322. The orifice member 336 may provide the flow restriction to the pressurized hydraulic fluid. Thus, the pressurized flow from the hydraulic pump 331 may be divided into the first portion and the second portion at the first end 340 of the orifice member 336. Further, a pressure of the first portion of the pressurized fluid may be reduced due to flow through the orifice member 336. Thus, a reduced pressure and flow rate of the hydraulic fluid is supplied to the rod end 328 of the hydraulic chamber 316. The first portion of the pressurized hydraulic fluid may then drive the fuel piston 322 along the first direction D1 within the fuel chamber 302.

The second check valve 348 is fluidly communicated with the first fluid line 338 and may allow unidirectional flow of the second portion of the pressurized hydraulic fluid to the accumulator 346 for storage. The second portion of the pressurized hydraulic fluid may be diverted to the accumulator 346 through the second check valve 348 while supplying the first portion of the hydraulic fluid through the orifice member 336 to the hydraulic chamber 316. The second portion of the pressurized hydraulic fluid may be stored in the accumulator 346 at the predetermined pressure.

At step 504, the valve system 332 is moved to a second configuration. The second configuration of the valve system 332 may be associated with the compression stroke of the fuel piston 322. During the compression stroke, the valve body of the directional valve 334 moves to the second position upon receipt of the control signal from the controller 214. In the second position, the hydraulic pump 331 fluidly communicates with the second fluid line 352. In an embodiment, the hydraulic pump 331 may supply the pressurized hydraulic fluid to the head end 330 of the hydraulic chamber 316 at a pressure substantially equal to the pressure during the suction stroke of the fuel pump 134. Therefore, a power required by the hydraulic pump 331 may remain same during the suction and compression strokes of the fuel pump 134. Consequently, a load applied on the engine 114 by the hydraulic pump 331 may remain substantially same during the suction and compression strokes.

Further, at step 506, in the second configuration of the valve system 332, the discharge valve 350 that is disposed between the accumulator 346 and the second fluid line 352 may be actuated to the open position upon receipt of the pressurized fluid from the hydraulic pump 331 in the second fluid line 352 via the pilot line 356. The discharge valve 350 discharges the pressurized hydraulic fluid stored within the accumulator 346 to the second fluid line 352 of the hydraulic chamber 316. Thus, the discharged hydraulic fluid from the accumulator 346 and the pressurized hydraulic fluid from the hydraulic pump 331 are both provided to the head end 330 of the hydraulic chamber 316 in order to drive the fuel piston 322 to travel along the second direction D2. When the fuel piston 322 travels along the second direction D2, LNG present in the fuel chamber 302 may be pressurized and pressurized LNG may then pass through the heat exchanger 138 and then to the engine 114.

Though the pressure and flow rate of the pressurized hydraulic fluid provided by the hydraulic pump 331 may be substantially same during both the suction and compression strokes of the fuel pump 134, the additional flow of the discharged hydraulic fluid from the accumulator 346 may supplement the flow of the hydraulic fluid from the hydraulic pump 331. Therefore, the combined flows of the discharged fluid from the accumulator 346 and the pressurized hydraulic fluid from the hydraulic pump 331 may provide a required flow rate and pressure to drive the fuel piston 322 during the compression stroke. The suction stroke and the compression stroke together may be defined as a cycle of the fuel pump 134. The hydraulic system 300 may therefore be able to drive the fuel pump 134 during one cycle keeping a load applied on the engine 114 by the hydraulic pump 331 substantially same. Consequently, a load applied on the engine 114 may not vary during a change of direction of the fuel piston 322 in the fuel pump 134. Further, with the first configuration and the second configuration of the valve system 332 of the present disclosure, a power output rating of the hydraulic pump 331 may be scaled down as the maximum power requirement of the hydraulic pump 331 to drive the fuel pump 134 is reduced.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A fuel supply system for an engine, the fuel supply system comprising:
a fuel source;
a fuel pump in fluid communication with the fuel source, the fuel pump comprising:
a fuel chamber configured to receive a fuel therein from the fuel source,
a hydraulic chamber configured to receive a hydraulic fluid therein, and
a fuel piston slidably received within the fuel chamber, the fuel piston being configured to compress the fuel during a compression stroke thereof and to draw in the fuel into the fuel chamber during a suction stroke thereof, wherein the fuel piston is drivable by the hydraulic fluid received within the hydraulic chamber;
a hydraulic pump drivably connected to the engine, the hydraulic pump configured to provide pressurized hydraulic fluid;
a valve system fluidly disposed between the hydraulic pump and the fuel pump; and
an accumulator disposed in fluid communication with the valve system;
wherein during the suction stroke of the fuel piston, the valve system is configured to provide a first portion of pressurized hydraulic fluid to the hydraulic chamber of the fuel pump to drive the fuel piston in a first direction and to provide a second portion of pressurized hydraulic fluid to the accumulator for storage; and
wherein during the compression stroke of the fuel piston, the valve system is configured to provide pressurized hydraulic fluid to the hydraulic chamber of the fuel pump to drive the fuel piston in a second direction, wherein the accumulator is configured to selectively release the stored pressurized fluid to the hydraulic chamber of the fuel pump to facilitate the drive of the fuel piston in the second direction.

2. The fuel supply system of claim 1, wherein the fuel source contains liquefied natural gas.

3. The fuel supply system of claim 1, wherein the fuel pump is a cryogenic piston pump.

4. The fuel supply system of claim 1, wherein the fuel pump further comprises a hydraulic piston slidably received within the hydraulic chamber, the hydraulic piston being operatively connected to the fuel piston and driven by the pressurized hydraulic fluid, wherein the hydraulic piston defines a rod end and a head end within the hydraulic chamber.

5. The fuel supply system of claim 4, further comprising a directional valve fluidly disposed between the hydraulic pump and the valve system, the directional valve being configured to:
provide the pressurized hydraulic fluid received from the hydraulic pump to the rod end of the hydraulic chamber during the suction stroke of the fuel piston; and
provide the pressurized hydraulic fluid received from the hydraulic pump to the head end of the hydraulic chamber during the compression stroke of the fuel piston.

6. The fuel supply system of claim 5, wherein the directional valve is in fluid communication with a hydraulic tank, wherein the directional valve is further configured to:
provide hydraulic fluid from the head end of the hydraulic chamber to the hydraulic tank during the suction stroke of the fuel piston; and
provide hydraulic fluid from the rod end of the hydraulic chamber to the hydraulic tank during the compression stroke of the fuel piston.

7. The fuel supply system of claim 1, wherein the valve system comprises an orifice member disposed between the hydraulic pump and both of the hydraulic chamber and the accumulator, the orifice member configured to receive the pressurized hydraulic fluid from the hydraulic pump during the suction stroke of the fuel piston.

8. The fuel supply system of claim 1, wherein the valve system further comprises a discharge valve disposed between the accumulator and the head end of the hydraulic chamber, the discharge valve configured to selectively permit the accumulator to discharge during the compression stroke of the fuel piston.

9. The fuel supply system of claim 8, wherein the discharge valve is a pilot operated valve.

10. A machine comprising:
an engine;
a hydraulic pump drivably connected to the engine, the hydraulic pump configured to provide pressurized hydraulic fluid;
a valve system in fluid communication with the hydraulic pump;
an accumulator disposed in fluid communication with the valve system;
a fuel source;
a fuel pump in fluid communication with the fuel source and the valve system, the fuel pump comprising:
a fuel chamber configured to receive a fuel therein from the fuel source and a hydraulic chamber configured to receive the pressurized hydraulic fluid therein from the valve system; and
a fuel piston slidably received within the fuel chamber, the fuel piston being configured to compress the fuel during a compression stroke thereof and to draw in the fuel into the fuel chamber during a suction stroke thereof, wherein the fuel piston is drivable by the hydraulic fluid received within the hydraulic chamber;
wherein during the suction stroke of the fuel piston, the valve system is configured to provide a first portion of the pressurized hydraulic fluid to the hydraulic chamber of the fuel pump to drive the fuel piston in a first direction and to provide a second portion of the pressurized hydraulic fluid to the accumulator for storage; and
wherein during the compression stroke of the fuel piston, the valve system is configured to provide the pressurized hydraulic fluid to the hydraulic chamber of the fuel pump to drive the fuel piston in a second direction, wherein the accumulator is configured to selectively release the stored pressurized fluid to the hydraulic chamber of the fuel pump to facilitate the drive of the fuel piston in the second direction.

11. The machine of claim 10, wherein the fuel source contains liquefied natural gas.

12. The machine of claim 10, wherein the fuel pump is a cryogenic piston pump.

13. The machine of claim 10, wherein the fuel pump further comprises a hydraulic piston slidably received within the hydraulic chamber, the hydraulic piston being operatively connected to the fuel piston and driven by the pressurized hydraulic fluid, wherein the hydraulic piston defines a rod end and a head end within the hydraulic chamber.

14. The machine of claim 13, further comprising a directional valve fluidly disposed between the hydraulic pump and the valve system, the directional valve being configured to:
provide the pressurized hydraulic fluid received from the hydraulic pump to the rod end of the hydraulic chamber during the suction stroke of the fuel piston; and
provide the pressurized hydraulic fluid received from the hydraulic pump to the head end of the hydraulic chamber during the compression stroke of the fuel piston.

15. The machine of claim 14, wherein the directional valve is in fluid communication with a hydraulic tank, wherein the directional valve is further configured to:
provide the hydraulic fluid from the head end of the hydraulic chamber to the hydraulic tank during the suction stroke of the fuel piston; and
provide the hydraulic fluid from the rod end of the hydraulic chamber to the hydraulic tank during the compression stroke of the fuel piston.

16. The machine of claim 10, wherein the valve system comprises an orifice member disposed between the hydraulic pump and both of the hydraulic chamber and the accumulator, the orifice member configured to receive the pressurized hydraulic fluid from the hydraulic pump during the suction stroke of the fuel piston.

17. The machine of claim 10, wherein the valve system further comprises a discharge valve disposed between the accumulator and the head end of the hydraulic chamber, the discharge valve configured to selectively permit the accumulator to discharge during the compression stroke of the fuel piston.

18. A method of supplying a fuel to an engine with a hydraulic system, the hydraulic system comprising a hydraulic pump drivably coupled to the engine to provide pressurized hydraulic fluid to a hydraulic chamber associated with a movement of a fuel piston of a fuel pump to compress fuel within a fuel chamber during a compression stroke and to draw in fuel within the fuel chamber during a suction stroke, the method comprising:
during the suction stroke, moving a valve system to a first configuration to facilitate providing a first portion of pressurized hydraulic fluid to the hydraulic chamber of the fuel pump to drive the fuel piston in a first direction, and providing a second portion of pressurized hydraulic fluid to an accumulator for storage;
during the compression stroke, moving the valve system to a second configuration to facilitate providing pressurized hydraulic fluid to the hydraulic chamber of the fuel pump to drive the fuel piston in a second direction; and
during the compression stroke, selectively releasing stored pressurized fluid within the accumulator to the hydraulic chamber of the fuel pump to facilitate the drive of the fuel piston in the second direction.

19. The method of claim 18, further comprising:
providing the pressurized hydraulic fluid received from the hydraulic pump to a rod end of the hydraulic chamber through a directional valve during the suction stroke of the fuel piston; and
providing the pressurized hydraulic fluid received from the hydraulic pump to a head end of the hydraulic chamber through the directional valve during the compression stroke of the fuel piston.

20. The method of claim 19, further comprising:
draining the hydraulic fluid from the head end of the hydraulic chamber to a hydraulic tank through the directional valve during the suction stroke of the fuel piston; and
draining the hydraulic fluid from the rod end of the hydraulic chamber to the hydraulic tank through the directional valve during the compression stroke of the fuel piston.
